(19) United States
(12) Patent Application Publication
(10) Pub. No.: US 2017/0085166 A1
(43) Pub. Date: Mar. 23, 2017

(54) Speed. Of, Light. Engine. Number 2

(71) Applicant: Tim Leigh McCormick, Hollywood, FL (US)

(72) Inventor: Tim Leigh McCormick, Hollywood, FL (US)

(21) Appl. No.: 14/857,823

(22) Filed: Sep. 18, 2015

(51) Int. Cl. H02K 47/14; H02K 7/075

(52) U.S. Cl. CPC H02K 47/14; H02K 7/075; H02K 53/00

(57) ABSTRACT

There is provided in method for controlling an electrical engine, that operates by taking energy from a battery, turning it into a high energy electricity, Controlled by a computer that energize solenoids, Connected to solenoid rods, to rotate a crank. That is connected to a belt pulley, driving a belt, connected to a generator, that is Controlled Voltage regulated to a battery. And regenerating its own energy.

Engine that operates by taking-the energy from a battery, turning it into high energy electricity to run on, while regenerating its own Energy Supply. By replacing what electricity it's taken from the battery. Its power source.

### DETAILED DESCRIPTION OF THE INVENTION

Explanation, description of S.O.L.E. Number 2, this Engine is designed to continually supply itself with fuel/electricity.

Recharging itself. Through a we energized battery, charging a high voltage DC Power Supply, regulated by a computer, through which energizes Solinoid plungers, To Solinoid plunger rods, to turn Engine crank, And rotate crank pulley, Connected by a belt in turn rotating a DC generator pulley, Rotating DC generator returning fuel/electricity Through voltage regulation by the computer, From the computer returning to the battery only what electricity has actually been used. Thus recharging the battery.

It's electrical Energy Supply.

The purpose of creating this engine is to produce a more efficient Power Supply/Dynamo, for the world.

The process of making and obtaining material, can be sought through any major independent fabricating engine manufacturing company.

### BRIEF SUMMARY OF INVENTION

A Engine/Power Plant-Dynamo that Takes power from a battery to operate, a high voltage DC Power Supply to then send high voltage to electrical Solinoid's, Connected to Solinoid rods Connected to a balanced engine crank, Turning The engine crank/harmonic balancer Connected to a pully, Turns a belt that is connected to another pully which turns a generator. While spinning the generator, Causing electrical charging fielding effect. Thus recharging/regenerating its own energy to the battery.

### CROSS REFERENCE TO RELATED APPLICATIONS

There is no cross reference to this application.

Because this is a completely original idea an original design.

None Found.

### STATEMENT REGARDING FEDERALLY SPONSORED RESEARCH FOR DEVELOPMENT

There is no federally sponsored research or Development To my knowledge regarding my design of the Speed. Of. Light. Engine. Number 2.

### BRIEF DESCRIPTION OF SEVERAL VIEWS OF DRAWING

FIG. 1, Page #1

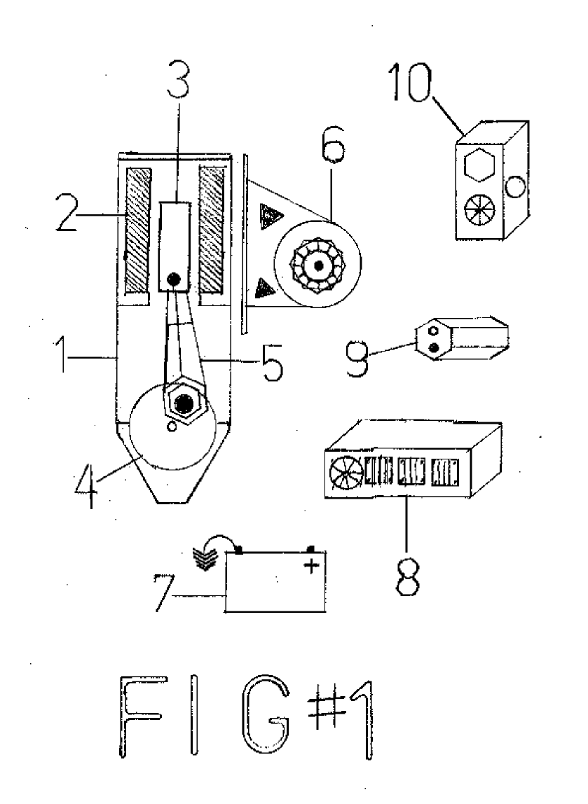

Front view of the engine block.

1. Engine block.

2. Solenoid windings.

3. Solenoid plunger.

4. Balanced engine crank.

5. Engine crank rod.

6. D.C. generator.

7. Battery.

8. High voltage D.C. Power Supply.

9. High voltage capacitor.

10. Computer.

11. Harmonic balancer/pulley.

FIG. 2, Page #2

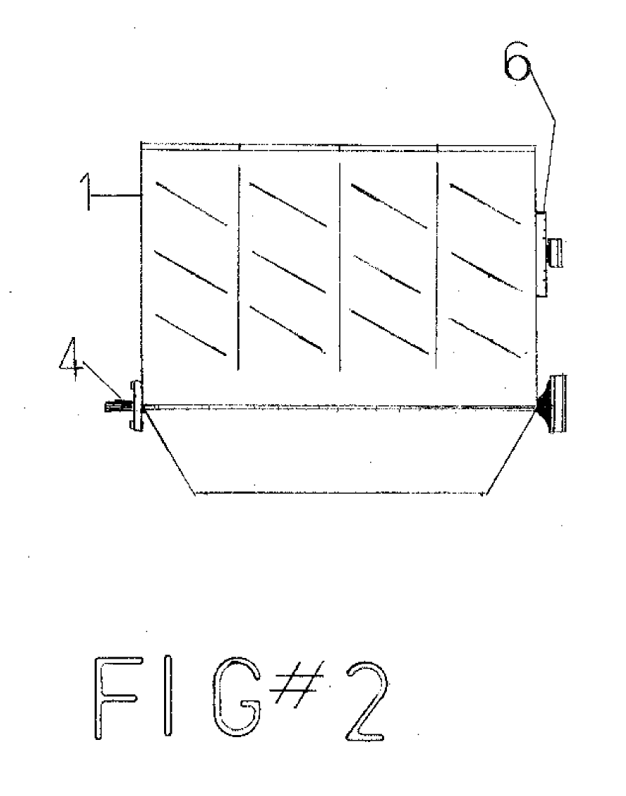

Right side view of the engine block.

1. Engine block.

2.

3.

4. Balanced engine crank.

5.

6. D.C. generator.

7.

8.

9.

10.

11. Harmonic balancer/pulley.

FIG. 3, Page #3

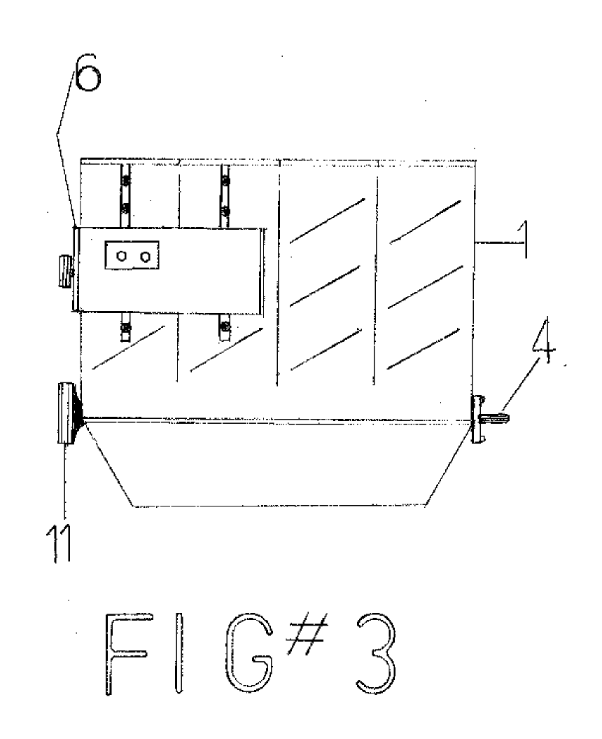

Left side view of the engine block.

1. Engine block.

2.

3.

4. Balanced engine crank.

5.

6. D.C. generator.

7.

8.

9.

10.

11. Harmonic balancer/pulley.

FIG. 4, Page #4

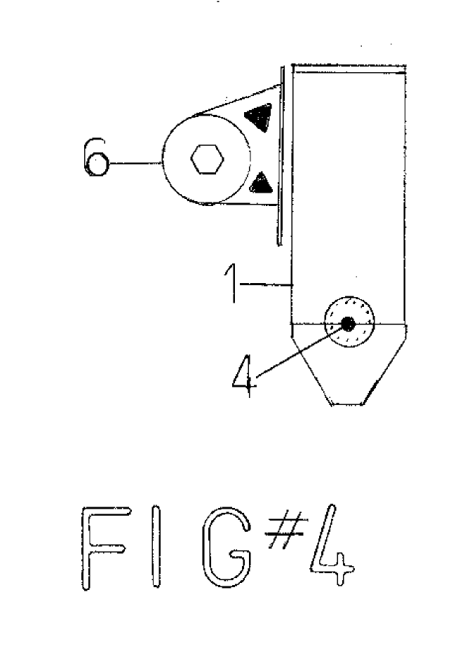

Rear view of the engine block.

1. Engine block.

2.

3.

4. Balanced engine crank.

5.

6. D.C. generator.

7.

8.

9.

10.

11.

FIG. 5, Page #5.

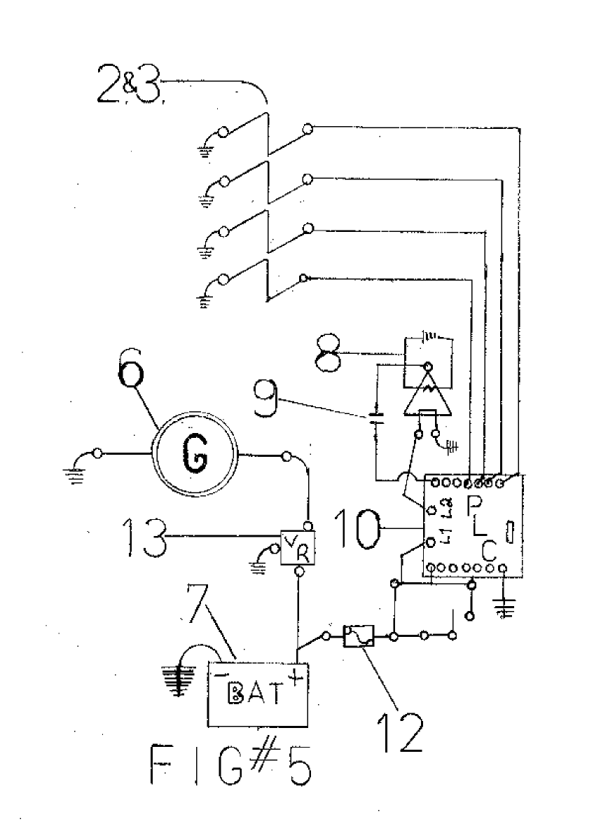

Electrical schematic.

1.

2. Solinoid Windings

3. Solinoid Plungers

4.

5.

6. D.C. Generator.

7. Battery.

8. High Voltage D.C. Power Supply.

9. High Voltage Capacitor.

10. Computer.

11.

12. Fuse.

13. Voltage Regulator.

1. What I Claim as my invention is the. Speed. Of. Light. Engine. Number 2.
The combination of technology of the formula for the design of the Power plant/Dynamo Named
